(19) United States
(12) Patent Application Publication
(10) Pub. No.: US 2011/0294313 A1
(43) Pub. Date: Dec. 1, 2011

(54) RECEPTACLE CONNECTOR

(75) Inventor: Michael Frank Cina, Elizabethtown, PA (US)

(73) Assignee: Tyco Electronics Corporation, Berwyn, PA (US)

(21) Appl. No.: 12/787,977

(22) Filed: May 26, 2010

(51) Int. Cl. H01R 12/14

(52) U.S. Cl. 439/78

(57) ABSTRACT

A receptacle connector is provided for mounting on a printed circuit having a contact mounting area and an incoming trace that extends into the contact mounting area. The receptacle connector includes a housing having a slot configured to receive a mating connector therein. The receptacle connector also includes an upper contact and a lower contact held by the housing. The upper and lower contacts include mating segments, mounting feet, and intermediate segments that extend between the mating segments and the mounting feet. The mounting foot of the lower contact is configured to be mounted on the incoming trace of the printed circuit such that the mounting foot creates a conductive path between the incoming trace and the intermediate segment of the lower contact. The conductive path forms part of a propagation path of electrical current through the electrical trace and the lower contact.

### BACKGROUND OF THE INVENTION

The subject matter herein relates generally to a transceiver assembly, and more particularly, to a receptacle connector for use in a transceiver assembly.

Various types of fiber optic and copper based transceiver assemblies that permit communication between electronic host equipment and external devices are known. These transceiver assemblies typically include a module assembly that can be pluggably connected to a receptacle in the host equipment to provide flexibility in system configuration. The module assemblies are constructed according to various standards for size and compatibility, one standard being the Quad Small Form-factor Pluggable (QSFP) module standard. Conventional QSFP modules and receptacle assemblies perform satisfactorily carrying data signals at rates up to 10 gigabits per second (Gbps). Another pluggable module standard, the XFP standard, calls for the transceiver module to also carry data signals at rates up to 10 Gbps.

The pluggable modules are plugged into a transceiver assembly that is mounted on a printed circuit (sometimes referred to as “circuit boards” or “printed circuit boards”) within the host equipment. The transceiver assembly includes an elongated guide frame, or cage, having a front that is open to an interior space, and a receptacle connector disposed at a rear of the cage within the interior space. Both the receptacle connector and the guide frame are electrically and mechanically connected to the printed circuit. When the pluggable module is plugged into the transceiver assembly, the pluggable module is electrically and mechanically connected to the printed circuit via the transceiver assembly.

Problems arise with mounting the receptacle connectors to the printed circuit. For example, the receptacle connector includes electrical contacts having mounting feet that are mounted on the printed circuit. The mounting feet engage electrical traces on the printed circuit to electrically connect the electrical contacts of the receptacle connector to the printed circuit. However, the mounting foot of one or more of the electrical contacts of the receptacle connector may generate an electrical stub when mounted on the corresponding electrical trace of the printed circuit. Specifically, electrical current flows through an electrical trace and into and through the corresponding electrical contact along a propagation path, which is the shortest path through the electrical trace and the corresponding electrical contact. An electrical stub is an open-ended conductive path that branches off from the propagation path. When mounted on the corresponding electrical trace, a segment (e.g., the free end) of a mounting foot may extend outside of the propagation path through the mounting foot and the corresponding electrical trace. The mounting foot may thereby generate an electrical stub, which may undesirably reduce data transmission rates through the electrical contact.

### BRIEF DESCRIPTION OF THE INVENTION

In one embodiment, a receptacle connector is provided for mounting on a printed circuit having a contact mounting area and an incoming trace that extends into the contact mounting area. The receptacle connector includes a housing having a slot configured to receive a mating connector therein. The receptacle connector also includes an upper contact and a lower contact held by the housing. The upper and lower contacts include mating segments, mounting feet, and intermediate segments that extend between the mating segments and the mounting feet. The mounting foot of the lower contact is configured to be mounted on the incoming trace of the printed circuit such that the mounting foot creates a conductive path between the incoming trace and the intermediate segment of the lower contact. The conductive path forms part of a propagation path of electrical current through the electrical trace and the lower contact.

In another embodiment, a transceiver assembly includes a receptacle guide frame configured to be mounted to a printed circuit having a contact mounting area and an incoming trace that extends into the contact mounting area in an incoming direction. The receptacle guide frame has a front being open to an interior space. The receptacle guide frame is configured to receive a pluggable module through the front. A receptacle connector is received within the interior space of the receptacle guide frame at a rear of the receptacle guide frame. The receptacle connector includes a housing comprising a slot configured to receive a mating connector therein, and an upper contact and a lower contact held by the housing. The upper and lower contacts include mating segments, mounting feet, and intermediate segments that extend between the mating segments and the mounting feet. The mounting foot of the lower contact is configured to be mounted on the incoming trace of the printed circuit such that the mounting foot extends outwardly from the intermediate segment of the lower contact in a foot direction that opposes the incoming direction of the incoming trace.

In another embodiment, a receptacle connector includes a housing extending from a front to a rear. The housing includes a slot that extends into the front and is configured to receive a mating connector therein. The receptacle connector also includes an upper contact and a lower contact held by the housing. The upper and lower contacts include mating segments, intermediate segments extending from the mating segments, and mounting feet that extend outwardly from the intermediate segments. The mounting feet of the upper and lower contacts are configured to be mounted to the printed circuit and extend outwardly from the intermediate segments in different directions from each other. The mounting foot of the lower contact extends outwardly from the intermediate segment of the lower contact in a direction toward the front of the housing.

### BRIEF DESCRIPTION OF THE DRAWINGS

FIG. 1 is an exploded perspective view of an exemplary embodiment of a transceiver assembly.

FIG. 2 is an assembled perspective view of a portion of the transceiver assembly shown in FIG. 1, showing an exemplary pluggable module mated with an exemplary embodiment of a receptacle assembly of the transceiver assembly.

FIG. 3 is a cross sectional view of a portion of the transceiver assembly shown in FIG. 1, showing the pluggable module mated with the receptacle assembly.

FIG. 4 is a rear perspective view of an exemplary embodiment of a receptacle connector of the receptacle assembly shown in FIGS. 2 and 3.

FIG. 5 is a perspective view of an exemplary embodiment of an upper contact of the receptacle connector shown in FIG. 4.

FIG. 6 is a perspective view of an exemplary embodiment of a lower contact of the receptacle connector shown in FIG. 4.

FIG. 7 is a partially broken-away perspective view of a portion of the receptacle connector shown in FIG. 4.

FIG. 8 is another partially broken-away perspective view of a portion of the receptacle connector shown in FIG. 4 illustrating the electrical contacts of the receptacle connector mounted on an exemplary embodiment of a host printed circuit of the transceiver assembly shown in FIG. 1.

### DETAILED DESCRIPTION OF THE INVENTION

FIG. 1 illustrates a transceiver assembly 100 adapted to address, among other things, conveying data signals at high rates, such as data transmission rates of 10 gigabits per second (Gbps) required of the SFP+standard. It is appreciated, however, that the benefits and advantages of the subject matter described and/or herein may accrue equally to other data transmission rates and across a variety of systems and standards.

As shown in FIG. 1, the assembly 100 generally includes a pluggable module 102 configured for pluggable insertion into a receptacle assembly 104 that is mounted to a host printed circuit 106, which, in turn, is mounted in a host system (not shown) such as, but not limited to, a router, a computer, and/or the like. The host system typically includes a conductive chassis having a bezel 108 including openings 109 therethrough in substantial alignment with a respective receptacle assembly 104. The pluggable module 102 is inserted into the receptacle assembly 104 through the bezel opening 109, and the receptacle assembly 104 is electrically connected to the bezel 108.

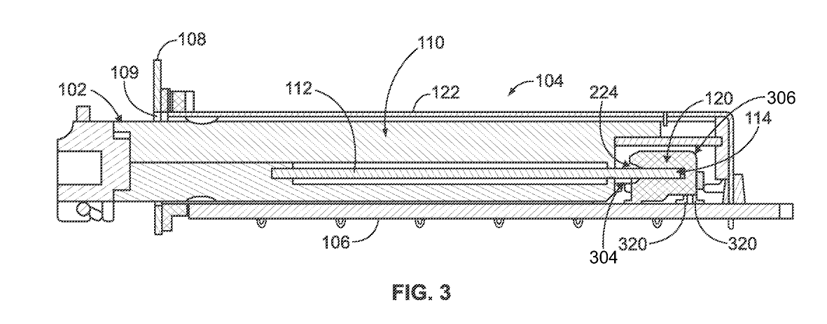

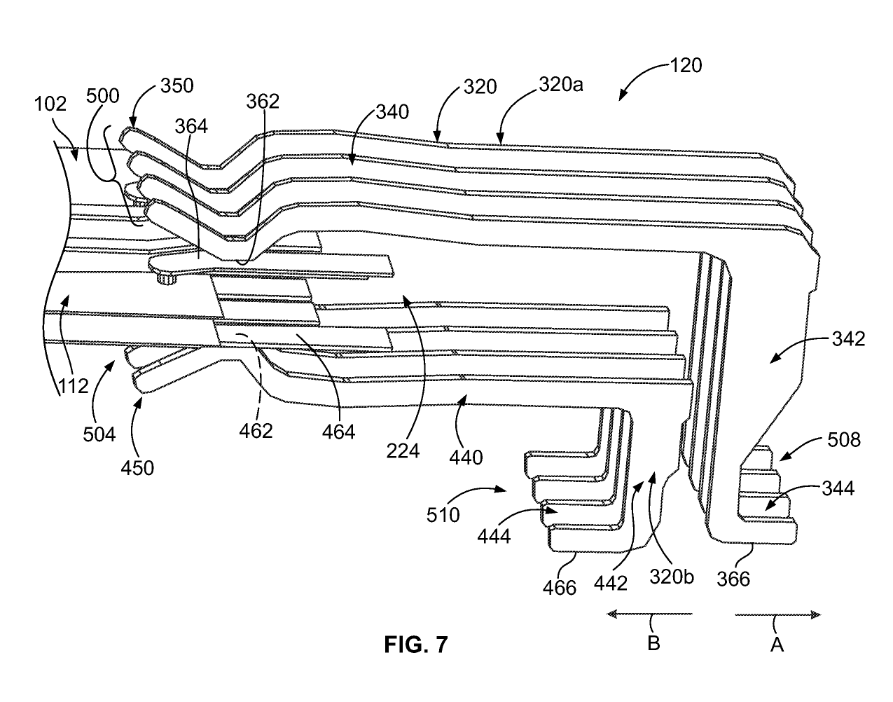

In the illustrated embodiment, the pluggable module 102 includes a housing 110 that forms a protective shell for a printed circuit 112 (FIGS. 3 and 7) that is disposed within the housing 110. The printed circuit 112 carries electronic circuitry and devices that perform transceiver functions in a known manner. An edge 114 (FIG. 3) of the printed circuit 112 is exposed through a rear of the housing 110, and the edge 114 is pluggable into the receptacle assembly 104 as described below. Alternatively, a connector may be mounted to the printed circuit 112 and exposed through the rear of the housing 110 for plugging into the receptacle assembly 104. The pluggable module 102 is adapted for installation into the receptacle assembly 104 such that a front end 118 of the pluggable module 102 is extended therefrom.

The pluggable module 102 is configured to be inserted into the receptacle assembly 104. In general, the pluggable module 102 and the receptacle assembly 104 may be used in any application requiring an interface between a host system and electrical or optical signals. The pluggable module 102 interfaces to the host system through the receptacle assembly 104 via a receptacle connector 120, which is located within a receptacle guide frame 122. The pluggable module 102 interfaces to an optical fiber or electrical cable (not shown) through a connector interface at the front end 118 of the pluggable module 102.

The pluggable module 102 and the receptacle assembly 104 reduce EMI emission through one or more of several EMI reduction features, including the receptacle guide frame 122 and one or more gasket assemblies 124. The receptacle connector 120 is mounted on the host printed circuit 106 of the host equipment separate from the receptacle guide frame 122 and gasket assemblies 124. The receptacle connector 120 includes a slot that receives the edge 114 of the printed circuit 112 or a connector mounted to the printed board 112 that is carried by the pluggable module 102 when the pluggable module 102 is fully installed in the receptacle guide frame 122, thereby electrically connecting the pluggable module 102 to the host equipment.

The receptacle guide frame 122 accommodates an optional heat sink 150. The heat sink 150 is positioned to engage the pluggable module 102 when the pluggable module 102 is installed into the receptacle assembly 104. A clip 152 is mounted over the heat sink 150 and is secured to the receptacle guide frame 122. The clip 152 ensures that the heat sink 150 is loaded against the pluggable module 102 to facilitate thermal transfer from the pluggable module 102 to the heat sink 150.

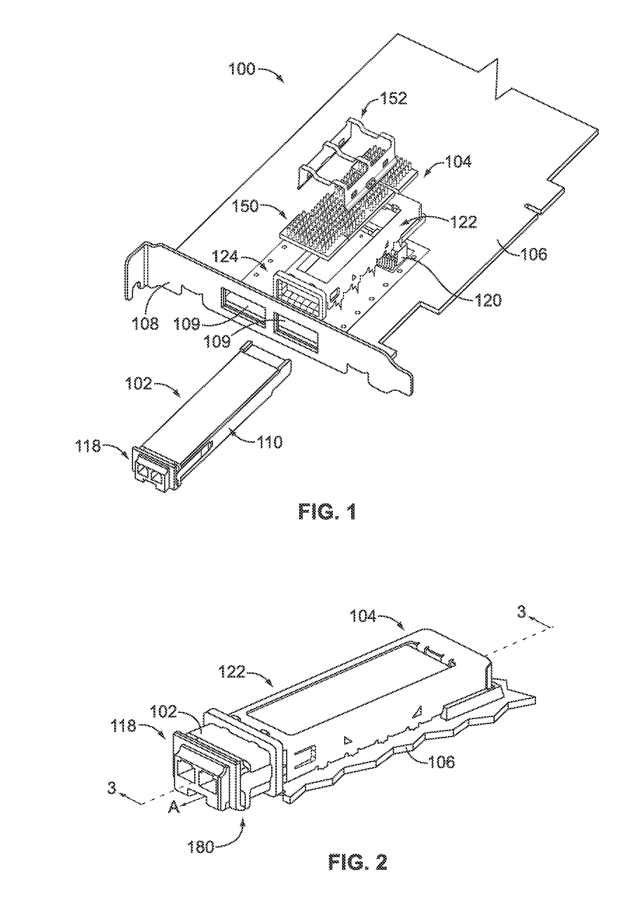

FIG. 2 is a perspective view of the receptacle assembly 104 mounted to the host circuit board 106 and receiving the pluggable module 102, with the heat sink 150 (FIG. 1) and the clip 152 (FIG. 1) removed for clarity. Also, the bezel 108 is not shown in FIG. 2.

The pluggable module 102 is illustrated in a latched position wherein removal from the receptacle guide frame 122 is prevented. An axial pull on the front end 118 of the pluggable module 102 in the direction of arrow A, when latched, is ineffective to remove the pluggable module 102. An ejector mechanism 180 is provided on the front end 118 of the pluggable module 102 for unlatching the pluggable module 102 for removal from the receptacle guide frame 122.

FIG. 3 is a cross sectional view of the pluggable module 102 coupled to the receptacle assembly 104 with the pluggable module 102 in the latched position. The pluggable module 102 includes the printed circuit 112 therein. The edge 114 of the printed circuit 112 is received in a connector slot 224 of the receptacle connector 120, which is mechanically and electrically mounted to the host printed circuit 106. The receptacle connector 120 includes electrical contacts 320 that engage conductive terminations on the printed circuit 112 to establish an electrical connection between the printed circuit 112 and electrical traces and/or other conductive paths on the host printed circuit 106. When the pluggable module 102 is inserted into the receptacle guide frame 122, the edge 114 of the printed circuit 112 is inserted into the connector slot 224. When the pluggable module 102 is fully inserted into the receptacle guide frame 122, the pluggable module 102 is locked in the latched position with the printed circuit 112 fully engaged with the receptacle connector 120.

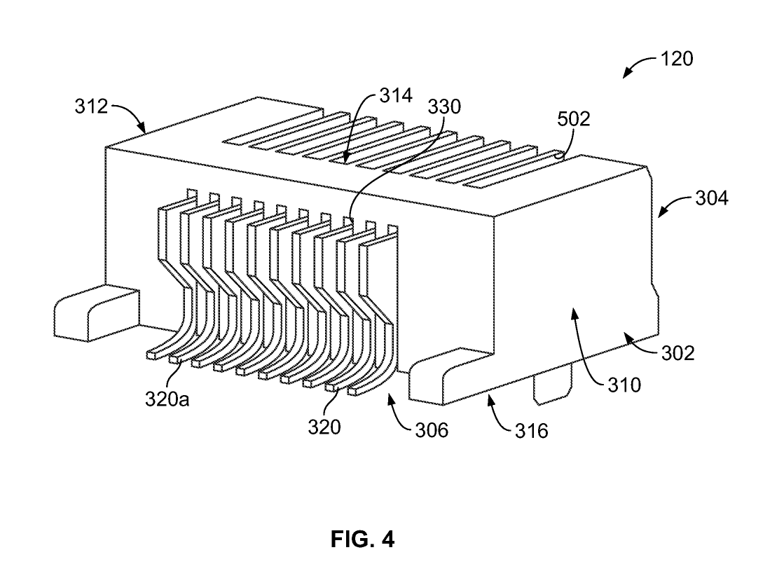

FIG. 4 is a rear perspective view of the receptacle connector 120 for the receptacle assembly 104 (FIGS. 1-3). The receptacle connector 120 includes a housing 302 having a front 304 and a rear 306. The receptacle connector 120 is configured to mate with a mating connector (e.g., the pluggable module 102 (FIGS. 1-3)), at the front 304. For example, the printed circuit 112 (FIGS. 3 and 7) may be received in the connector slot 224 (FIGS. 3 and 7), which extends through the front 304 of the housing 302. The housing 302 includes opposite sides 310 and 312, a top 314, and a bottom 316 that is opposite the top 314. The housing 302 is configured to be mounted on a printed circuit (e.g., the host printed circuit 106) at the bottom 316.

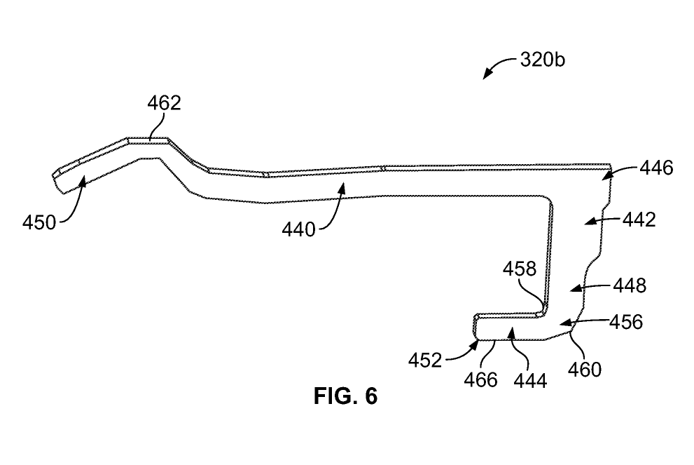

The contacts 320 of the receptacle connector 120 are held by the housing 302. The contacts 320 are loaded through the rear 306 of the housing 302. As will be described below, the contacts 320 include upper contacts 320a and lower contacts 320b (FIGS. 6-8). The lower contacts 320b are not visible in FIG. 4. Each of the contacts 320 may be a signal contact, a ground contact, or a power contact. Optionally, contacts 320 used as signal contacts may be arranged in pairs with each signal contact within a pair carrying a differential signal, thus defining differential pairs. Ground contacts may be provided between the pairs of signal contacts. Any other contact arrangement may be provided.

The housing 302 includes a plurality of grooves 330 formed therein at the rear 306 of the housing 302. The grooves 330 receive corresponding contacts 320 therein and enable both the upper and lower contacts 320a and 320b, respectively, to be loaded into the housing through the rear 306. Alternatively, the upper contacts 320a and/or the lower contacts 320b are loaded through the front 304, the side 310, the side 312, the top 314, and/or the bottom 316 of the housing 302. The grooves 330 may facilitate holding the contacts 320 in position relative to one another (e.g. side-to-side position).

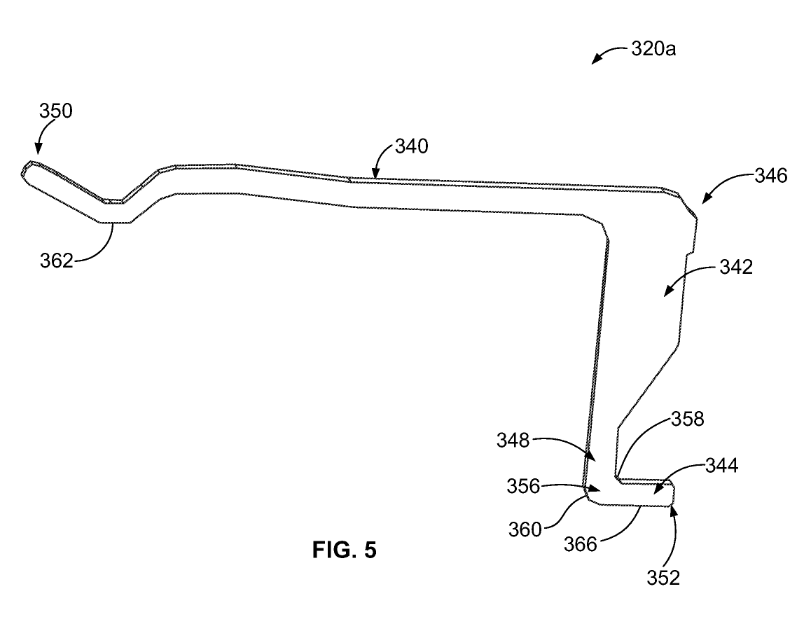

FIG. 5 is a perspective view of an exemplary embodiment of one of the upper contacts 320a. The upper contact 320a includes a mating segment 340, an intermediate segment 342, and a mounting foot 344. The intermediate segment 342 extends between the mating segment 340 and the mounting foot 344. Specifically the intermediate segment 342 extends from an end 346 to an opposite end 348. The mating segment 342 extends from the end 346 of the intermediate segment 342, while the mounting foot 344 extends from the opposite end 348 of the intermediate segment 342. The mating segment 342 extends outwardly from the intermediate segment 342 to a free end 350. The mounting foot 344 extends outwardly from the intermediate segment 342 to a free end 352. Optionally, the mounting foot 344 extends outwardly from the intermediate segment 342 at a bend 356 such that the mounting foot 344 is angled relative to at least a portion of the intermediate segment 342. The bend 356 includes a radially inner edge 358 and a radially outer edge 360.

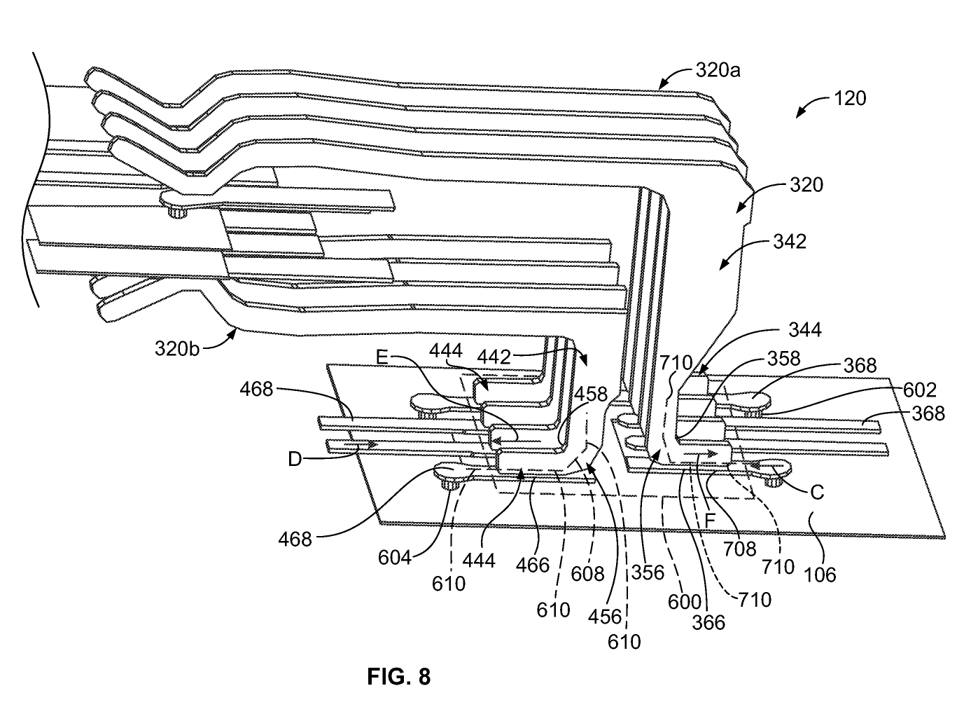

The mating segment 342 includes a mating interface 362. The upper contact 320a is configured to mate with a corresponding conductive termination 364 (FIG. 7) on the printed circuit 112 (FIGS. 3 and 7) at the mating interface 362 to electrically connect the upper contact 320a to the printed circuit 112. The mating interface 362 is defined by a mating surface of the mating segment 342 that engages the corresponding conductive termination 364 of the printed circuit 112. The mounting foot 344 includes a mounting interface 366 for mounting the upper contact 320a on the host printed circuit 106 (FIGS. 1-3 and 8). The mounting interface 366 is defined by a mounting surface of the mounting foot 344 that engages a corresponding electrical trace 368 (FIG. 8) of the host printed circuit 106. Optionally, the mounting foot 344 is soldered to the corresponding electrical trace 368.

In the exemplary embodiment, the mounting foot 344 extends outwardly from the intermediate segment 342 in an opposite direction relative to the direction that the mating segment 340 extends from the intermediate segment 342, such that the mating segment 340 and the mounting foot 344 extend approximately parallel to each other. But, the mounting foot 344 may extend outwardly from the intermediate segment 342 in any direction, and at any angle, relative to the direction and angle that the mating segment 340 extends from the intermediate segment 342.

FIG. 6 is a perspective view of an exemplary embodiment of one of the lower contacts 320b. The lower contact 320b includes a mating segment 440, an intermediate segment 442, and a mounting foot 444. The intermediate segment 442 extends between the mating segment 440 and the mounting foot 444. Specifically the intermediate segment 442 extends from an end 446 to an opposite end 448. The mating segment 442 extends from the end 446 of the intermediate segment 442, while the mounting foot 444 extends from the opposite end 448 of the intermediate segment 442.

The mating segment 442 extends outwardly from the intermediate segment 442 to a free end 450. The mounting foot 444 extends outwardly from the intermediate segment 442 to a free end 452. Optionally, the mounting foot 444 extends outwardly from the intermediate segment 442 at a bend 456 such that the mounting foot 444 is angled relative to at least a portion of the intermediate segment 442. The bend 456 includes a radially inner edge 458 and a radially outer edge 460.

The mating segment 442 of the lower contact 320b includes a mating interface 462. The lower contact 320b is configured to mate with a corresponding conductive termination 464 (FIG. 7) on the printed circuit 112 (FIGS. 3 and 7) at the mating interface 462 to electrically connect the lower contact 320b to the printed circuit 112. The mating interface 462 is defined by a mating surface of the mating segment 442 that engages the corresponding conductive termination 464 of the printed circuit 112. The mounting foot 444 includes a mounting interface 466 for mounting the lower contact 320b on the host printed circuit 106 (FIGS. 1-3 and 8). The mounting interface 466 is defined by a mounting surface of the mounting foot 444 that engages a corresponding electrical trace 468 (FIG. 8) of the host printed circuit 106. Optionally, the mounting foot 444 is soldered to the corresponding electrical trace 468.

In the exemplary embodiment, the mounting foot 444 extends outwardly from the intermediate segment 442 in the same direction relative to the direction that the mating segment 440 extends from the intermediate segment 442, such that the mating segment 440 and the mounting foot 444 extend approximately parallel to each other. But, the mounting foot 444 may extend outwardly from the intermediate segment 442 in any direction, and at any angle, relative to the direction and angle that the mating segment 440 extends from the intermediate segment 442.

FIG. 7 is a partially broken-away perspective view of a portion of the receptacle connector 120. The housing 302 has been removed from FIG. 7 for clarity. The contacts 320 of the receptacle connector 120 are held within the housing 302 (FIG. 4) and are configured for mating with the pluggable module 102 (only a portion of which is shown in FIG. 7). Specifically, a plurality of the upper contacts 320a are arranged in an upper row 500. The mating segment 340 of each of the upper contacts 320a extends from the intermediate segment 342 into a corresponding slot 502 (FIG. 4) formed in the housing 302 through the front 304 (FIGS. 3 and 4). Each mating interface 362 of the upper contacts 320a is exposed within the connector slot 224 (best seen in FIG. 3) for engagement with the corresponding conductive termination 364 on the printed circuit 112 of the pluggable module 102, as shown in FIG. 7.

A plurality of the lower contacts 320b are arranged in a lower row 504. The mating segment 440 of each of the lower contacts 320b extends from the intermediate segment 442 into a corresponding slot (not shown) formed in the housing 302 through the front 304. Each mating interface 462 of the lower contacts 320b is exposed within the connector slot 224 (best seen in FIG. 3) for engagement with the corresponding conductive termination 464 on the printed circuit 112 of the pluggable module 102, as shown in FIG. 7. As can also be seen in FIG. 7, the mating interfaces 362 of the upper contacts 320a oppose the mating interfaces 462 of the lower contacts 320b within the connector slot 224. Moreover, in the exemplary embodiment, the mating segments 340 and 440 of the upper and lower contacts 320a and 320b, respectively, extend from the respective free ends 350 and 450 toward the respective intermediate segments 342 and 442 in the same direction as each other.

The mounting feet 344 of the upper contacts 320a are aligned with each other in a row 508 for mounting to the host circuit board 106 (FIGS. 1-3 and 8). The mounting interfaces 366 of the mounting feet 344 of the upper contacts 320a are optionally held approximately coplanar with one another for mounting to the host circuit board 106. Optionally, the mounting feet 344 of the upper contacts 320a extend outwardly from the intermediate segments 342 in a direction away from the front 304 of the housing 302. Similar to the upper contacts 320a, the mounting feet 444 of the lower contacts 320b are aligned with each other in a row 510 for mounting to the host circuit board 106. The mounting interfaces 466 of the mounting feet 444 of the lower contacts 320b are optionally held approximately coplanar with one another for mounting to the host circuit board 106. Optionally, and as should be apparent from FIG. 7, the mounting feet 444 of the lower contacts 320b extend outwardly from the intermediate segments 442 in a direction toward the front 304 of the housing 302.

In the exemplary embodiment, the mounting feet 344 and 444 of the upper and lower contacts 320a and 320b, respectively, extend outwardly from the respective intermediate segments 342 and 442 in opposite directions from each other. Specifically, the mounting feet 344 of the upper contacts 320a extend outward from the intermediate segments 342 in a direction labeled with the arrow A, while the mounting feet 444 of the lower contacts 320b extend outward from the intermediate segments 442 in an opposite direction labeled with the arrow B. But, the mounting foot 344 of each lower contact 320b may extend outwardly from the intermediate segment 442 in any other direction (whether toward or away from) relative to the direction that the mounting foot 344 of any of the upper contacts 320b extends from the intermediate segment 342.

As can be seen in FIG. 7, the mounting feet 344 and 444 of the upper and lower contacts 320a and 320b, respectively, are positioned proximate each other. Moreover, it should be apparent from FIGS. 3 and 7 that the mounting feet 344 and 444 of the upper and lower contacts 320a and 320b, respectively, are positioned proximate the rear 306 of the housing 302. For example, the mounting feet 344 and 444 of the upper and lower contacts 320a and 320b, respectively, are each positioned closer to the rear 306 of the housing 302 than to the front 304 of the housing 302. The receptacle connector may include any number of the contacts 320 overall, including any number of the upper contacts 320a and any number of the lower contacts 320b.

FIG. 8 is another partially broken-away perspective view of a portion of the receptacle connector 120 illustrating the electrical contacts 320 mounted on the host printed circuit 106. The host printed circuit 106 includes a contact mounting area 600 and the electrical traces 368 and 468. The contact mounting area 600 receives the mounting feet 344 and 444 of the electrical contacts 320. Each electrical trace 368 and 468 extends from a corresponding origination point 602 and 604, respectively, on the host printed circuit 106 into the contact mounting area 600. As can be seen in FIG. 8, the origination points 602 and 604 are outside of the contact mounting area 600. Each origination point 602 and 604 may be any type of origination point, such as, but not limited to, a conductive via, an electrical module (not shown), an electrical component (not shown), an electronic package and/or chip (not shown), another connector (not shown), and/or the like.

Each electrical trace 368 and 468 extends into the contact mounting area 600 in a corresponding incoming direction C and D, respectively. As can be seen in FIG. 8, the mounting interfaces 466 of the mounting feet 444 of the lower contacts 320b are each engaged with the corresponding electrical trace 468 of the host printed circuit 106. Each mounting foot 444 creates a conductive path 608 between the corresponding electrical trace 468 and the corresponding intermediate segment 442. A propagation path 610 of electrical current is defined through the electrical trace 468 and the lower contact 320b. The propagation path 610 is the shortest path through the electrical trace 468 and the lower contact 320b. For example, the propagation path 610 includes the shortest path of electrical current from the electrical trace 468 to the intermediate segment 442 of lower contact 320b.

Each mounting foot 444 of the lower contacts 320b is configured to be mounted on the corresponding electrical trace 468 without creating an electrical stub. In the exemplary embodiment, the mounting foot 444 is mounted on the corresponding electrical trace 468 in a direction E that opposes the incoming direction D of the electrical trace 468. As can be seen in FIG. 8, the radially inner edge 458 of the bend 456 of the lower contact 320b therefore faces the incoming direction D of the electrical trace 468. The conductive path 608 between the electrical trace 468 and the intermediate segment 442 through the mounting foot 444 forms a part of the propagation path 610. No electrical stub is created by mounting the mounting foot 444 on the electrical trace 468 because the conductive path 608 does not include an open-ended path that branches off from the propagation path 610. Rather, the conductive path 608 lies completely within the propagation path 610.

In the exemplary embodiment, the direction E in which the mounting foot 444 is mounted on the corresponding electrical trace 468 is opposite to the incoming direction D of the electrical trace 468, such that the directions D and E are approximately parallel to each other. But, the direction E in which the mounting foot 444 is mounted on the corresponding electrical trace 468 could be any direction relative to the direction D (whether opposing or not) that does not create an electrical stub. As used herein, two directions “oppose” each other if the directions generally face toward each other. For example, “opposing” directions include directions that are opposite, and thus parallel, as well as directions that generally face toward each other but extend at an oblique angle relative to each other. The direction E may be referred to herein as a “foot direction”.

Turning to the upper contacts 320a, the mounting interfaces 366 of the mounting feet 344 of the upper contacts 320a are each engaged with the corresponding electrical trace 368 of the host printed circuit 106. Each mounting foot 344 creates a conductive path 708 between the corresponding electrical trace 368 and the corresponding intermediate segment 342. A propagation path 710 of electrical current is defined through the electrical trace 368 and the upper contact 320a. The propagation path 710 is the shortest path through the electrical trace 368 and the upper contact 320a. For example, the propagation path 710 includes the shortest path of electrical current from the electrical trace 368 to the intermediate segment 342 of upper lower contact 320a.

Similar to the lower contacts 320b, each mounting foot 344 of the upper contacts 320a is configured to be mounted on the corresponding electrical trace 368 without creating an electrical stub. In the exemplary embodiment, the mounting foot 344 is mounted on the corresponding electrical trace 368 in a direction F that opposes the incoming direction C of the electrical trace 368. The radially inner edge 358 of the bend 356 of the upper contact 320a therefore faces the incoming direction C of the electrical trace 368. The conductive path 708 between the electrical trace 368 and the intermediate segment 342 through the mounting foot 344 forms a part of the propagation path 710. No electrical stub is created by mounting the mounting foot 344 on the electrical trace 368 because the conductive path 708 does not include an open-ended path that branches off from the propagation path 710. Rather, the conductive path 708 lies completely within the propagation path 710. In the exemplary embodiment, the direction F in which the mounting foot 344 is mounted on the corresponding electrical trace 368 is opposite to the incoming direction C of the electrical trace 368, such that the directions C and F are approximately parallel to each other. But, the direction F in which the mounting foot 344 is mounted on the corresponding electrical trace 368 could be any direction relative to the direction C (whether opposing or not) that does not create an electrical stub. The direction F may be referred to herein as a “foot direction”.

Each of the electrical traces 368 and 468 may be referred to herein as an “incoming trace”. As used herein, the term “incoming” as applied to the electrical traces 368 and 468 is meant to indicate a physical path of the electrical traces 368 and 468 into the contact mounting area 600 rather than a direction of electrical current flowing through the electrical traces 368 and 468. It should be understood that electrical current may flow from the contacts 320 toward the corresponding trace 368 or 468 and/or from the corresponding trace 368 or 468 to the contacts 320. Although eight are shown, the host printed circuit 106 may include any number of electrical traces 368 and 468 overall, including any number of the electrical traces 368 and any number of the electrical traces 468.

As used herein, the term “printed circuit” is intended to mean any electric circuit in which the conducting connections have been printed or otherwise deposited in predetermined patterns on an electrically insulating substrate. Substrates of the printed circuits 106 and 112 may each be a flexible substrate or a rigid substrate. The substrates may be fabricated from and/or include any material(s), such as, but not limited to, ceramic, epoxy-glass, polyimide (such as, but not limited to, Kapton® and/or the like), organic material, plastic, polymer, and/or the like. In some embodiments, one or both of the substrates is a rigid substrate fabricated from epoxy-glass, such that the corresponding printed circuit 106 and/or 112 is what is sometimes referred to as a “circuit board” or a “printed circuit board”.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A receptacle connector for mounting on a printed circuit having a contact mounting area and an incoming trace that extends into the contact mounting area, said receptacle connector comprising:
a housing comprising a slot configured to receive a mating connector therein; and
an upper contact and a lower contact held by the housing, the upper and lower contacts comprising mating segments, mounting feet, and intermediate segments that extend between the mating segments and the mounting feet, the mounting foot of the lower contact being configured to be mounted on the incoming trace of the printed circuit such that the mounting foot creates a conductive path between the incoming trace and the intermediate segment of the lower contact, wherein the conductive path forms part of a propagation path of electrical current through the electrical trace and the lower contact.

2. The receptacle connector according to claim 1, wherein the mounting foot of the lower contact is configured to be mounted on the incoming trace of the printed circuit without generating an electrical stub.

3. The receptacle connector according to claim 1, wherein the conductive path extends completely within the propagation path.

4. The receptacle connector according to claim 1, wherein the incoming trace of the printed circuit extends into the contact mounting area in an incoming direction, the mounting foot of the lower contact being configured to be mounted on the incoming trace of the printed circuit such that the mounting foot extends outwardly from the intermediate segment of the lower contact in a foot direction that opposes the incoming direction of the electrical trace.

5. The receptacle connector according to claim 1, wherein the incoming trace of the printed circuit extends into the contact mounting area in an incoming direction, the mounting foot of the lower contact being configured to be mounted on the incoming trace of the printed circuit such that the mounting foot extends outwardly from the intermediate segment of the lower contact in a foot direction that is opposite the incoming direction of the electrical trace.

6. The receptacle connector according to claim 1, wherein the incoming trace of the printed circuit extends into the contact mounting area in an incoming direction, the mounting foot of the lower contact extending outwardly from the intermediate segment at a bend having radially inner and radially outer edges, the radially inner edge of the bend facing the incoming direction of the incoming trace.

7. The receptacle connector according to claim 1, wherein the housing extends from a front to a rear, the slot extending into the front, the mounting foot of the lower contact extending outwardly from the intermediate segment of the lower contact in a direction toward the front of the housing.

8. The receptacle connector according to claim 1, wherein the mating segment and the mounting foot of the lower contact extend outwardly from the intermediate segment in the same direction as each other.

9. The receptacle connector according to claim 1, wherein the housing extends between a pair of opposite ends, the upper contact and the lower contact being loaded into the housing through the same end of the housing.

10. A transceiver assembly comprising:
a receptacle guide frame configured to be mounted to a printed circuit having a contact mounting area and an incoming trace that extends into the contact mounting area in an incoming direction, the receptacle guide frame having a front being open to an interior space, the receptacle guide frame being configured to receive a pluggable module through the front; and
a receptacle connector received within the interior space of the receptacle guide frame at a rear of the receptacle guide frame, the receptacle connector comprising:
a housing comprising a slot configured to receive a mating connector therein; and
an upper contact and a lower contact held by the housing, the upper and lower contacts comprising mating segments, mounting feet, and intermediate segments that extend between the mating segments and the mounting feet, wherein the mounting foot of the lower contact is configured to be mounted on the incoming trace of the printed circuit such that the mounting foot extends outwardly from the intermediate segment of the lower contact in a foot direction that opposes the incoming direction of the incoming trace.

11. The transceiver assembly according to claim 10, wherein the foot direction is opposite the incoming direction of the electrical trace.

12. The transceiver assembly according to claim 10, wherein the mounting foot of the lower contact is configured to be mounted on the incoming trace of the printed circuit without generating an electrical stub.

13. The transceiver assembly according to claim 10, wherein the mounting foot of the lower contact is configured to be mounted on the incoming trace of the printed circuit such that electrical current flowing through the mounting foot follows a linear path through the mounting foot.

14. The transceiver assembly according to claim 10, wherein the mounting foot of the lower contact extends outwardly from the intermediate segment at a bend having radially inner and radially outer edges, the radially inner edge of the bend facing the incoming direction of the incoming trace.

15. The transceiver assembly according to claim 10, wherein the mounting feet of the upper and lower contacts extend outwardly from the intermediate segments in opposite directions to each other.

16. A receptacle connector comprising:
a housing extending from a front to a rear, the housing comprising a slot extending into the front and configured to receive a mating connector therein; and
an upper contact and a lower contact held by the housing, the upper and lower contacts comprising mating segments, intermediate segments extending from the mating segments, and mounting feet that extend outwardly from the intermediate segments, the mounting feet of the upper and lower contacts being configured to be mounted to a printed circuit and extending outwardly from the intermediate segments in different directions from each other, wherein the mounting foot of the lower contact extends outwardly from the intermediate segment of the lower contact in a direction toward the front of the housing.

17. The receptacle connector according to claim 16, wherein the mating segments of the upper and lower contacts extend from free ends toward the intermediate segments in the same direction as each other.

18. The receptacle connector according to claim 16, wherein the mounting foot of the lower contact is positioned proximate the rear of the housing.

19. The receptacle connector according to claim 16, wherein the mounting feet of the upper and lower contacts are positioned proximate each other.

20. The receptacle connector according to claim 16, wherein the mounting feet of the upper and lower contacts extend outwardly from the intermediate segments in opposite directions from each other.
